(19) United States
(12) Patent Application Publication
(10) Pub. No.: US 2017/0343343 A1
(43) Pub. Date: Nov. 30, 2017

(54) Positional Variance Based Distance Sensing Apparatus

(71) Applicants: Nagasai Sreyash Sola, Ashburn, VA (US); Hari Krishna Sola, Ashburn, VA (US)

(72) Inventors: Nagasai Sreyash Sola, Ashburn, VA (US); Hari Krishna Sola, Ashburn, VA (US)

(21) Appl. No.: 15/605,909

(22) Filed: May 25, 2017

Related U.S. Application Data
(60) Provisional application No. 62/342,736, filed on May 27, 2016.

(51) Int. Cl. G01B 21/16; G01D 5/00; G01C 22/00; H02K 37/00; A61H 3/00

(52) U.S. Cl. CPC G01B 21/16; H02K 37/00; A61H 3/00; G01C 22/00; G01D 5/00

(57) ABSTRACT

A positional variance based distance sensing apparatus has a physical marker that changes its position (either rotational or linear) in accordance to the distance of an object from the sensor. This positional change can be used to sense the distance using touch by humans. This positional variance can also be used to control triggers like switches, leavers, and steering based controllers.

### CROSS-REFERENCE TO RELATED APPLICATION

This application claims the benefit of U.S. Provisional Application No. US 62/342,736, filed May 27, 2016.

### BACKGROUND

### 1. Field of Invention

The present invention relates to the distance sensing of objects based on the position of a physical marker that changes its position (rotational or linear) based on the distance of the object from the sensor.

### 2. Description of the Related Art

In some scenarios it's little to very useful to get the sense of distance from an object for reasons like safety without actually looking at the object. In some cases, this can augment vision like helping field workers/officers get a sense of the changing scene around them without looking around. Especially for people with vision problems it's very important for them to somehow know or sense the distance of the surrounding objects so they can navigate safely without actually seeing the objects. The distance sensing is also useful to control triggers avoid dangers. For example, shutting down machinery if a person comes too close. And for defense forces too it's very helpful to get a sense of the distance of surrounding objects without actually looking at it when they are looking or focusing on other direction. Distance sensing apparatus for direct human consumption, fall broadly into two categories: 1. Visual based apparatus 2. Audio based apparatus.

Visual based range sensing needs a person to look at the screen or display to know the distance read by the apparatus. There are many applications to know the precise distance of the surrounding objects. But, this may not be helpful for certain situations or applications. For example, this method cannot be used by the blind. Also it may not be practical for situations where distance only changes rarely or unpredictably over a long periods of time where keeping an eye on the distance readings may not be practical.

Audio based distance sensing can read out accurate readings to the person using it. But this method interferes with person's ability to hear other sounds. Also if it is a speaker based apparatus, it may disturb everyone surrounding with the distance readings.

### BRIEF SUMMARY OF THE INVENTION

Positional variance based distance sensing apparatus uses one or more range/distance sensor(s), a microcontroller, power source and one or more motors providing positional variance based on the sensed distance. Distance sensed by the range sensor (ultra-sonic, infrared and like) is read by the microcontroller and converted into positional change in a positional variance attachment or marker (either rotational or linear). A stepper motor or like would be ideal for this kind of application. Depending on the amount of rotation or linear distance, a touch on the variance attachment with a reference position would provide sense of measured distance. When there are no obstacles in the direction of the sensor the variance attachment would be in its initial position. As the sensor approaches an object, the proximity is converted to the rotation by the microcontroller and turns the motor accordingly.

### BRIEF DESCRIPTION OF THE DRAWINGS

FIG. 1 shows the main components of this apparatus. Power source such as a battery or regular a/c power provides energy required for the micro controller, range sensor and the motor. This figure shows the apparatus in one sensor one motor configuration. But multiple sensors, motors can be added.

FIG. 2 shows the rotational(angular) variance attachment to the motor shaft.

FIG. 3 shows one of the linear variance attachment to the motor shaft. Here the angular rotation of the motor is converted to linear motion.

FIG. 4 shows the apparatus being used with the walking cane with angular variance attachment.

FIG. 5 shows the flow chart of the microcontroller program.

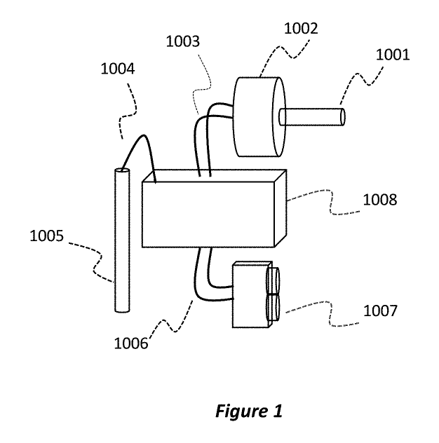

### DETAILED DESCRIPTION OF THE INVENTION

Positional variance based distance sensing apparatus consists of 4 main parts. 1. A microcontroller 1008 to sense readings from sensor and rotate motor 2. One or more range/distance sensors 1007 for distance sensing 3. One or more motors 1002 with shafts 1001 to indicate the distance range measured by the range sensors to positional variation 4. A power source 1005 to provide required power to the apparatus. Microcontroller is connected to range sensor 1006 for distance readings and connected 1003 to motor 1002 to rotate. It is connected 1004 to the power source like battery 1005. If needed individual sensors and or motors can be connected to directly to the power source (not depicted in the diagrams) for power.

When the microcontroller of the apparatus starts 5001, it is programmed to sense the distance from the range sensor 5002.

After reading the distance information, distance unit settings 5003 are applied. Unit settings provide basis for the rotational calculation of the motor. For example, with lower value for the unit setting, even the slight changes in distance would provide rotational feedback. Whereas higher unit settings would not cause rotation for slight changes in measured distance.

After calculating the rotational angle corresponding to the distance, the microcontroller program applies rotational band settings 5004 to avoid jittering rotation of the motor. Band is a range of distance values for which microcontroller outputs the same angular rotation. For example, angular rotation can be 0 degrees for distance sensed 0-10 units, 45 degrees for distance sensed 10-20 units, 90 degrees for distance sensed 20-30 units. This feature eliminates the jitter of rotational variance due to minor distance variances. With this kind of correction, the motor shaft rotates in specific steps instead of continuous movements.

Once applying the distance unit settings and rotational band settings, microcontroller calculates the angular rotation 5005 for the motor. Microcontroller then sends the signal to the motor 5006 which will rotate to intended angle, providing positional/angular variance feedback for the distance sensed by the range sensor.

Once this is done, depending on application a configurable sleep/wait time 5007 is applied for sensing the distance again. After completing the optional sleep/wait, microcontroller returns to the reading distance from the range sensor step 5002. This distance sensing and feedback cycle continues during the operation of this apparatus providing the continuous positional variance feedback for the distance sensed by the range sensor.

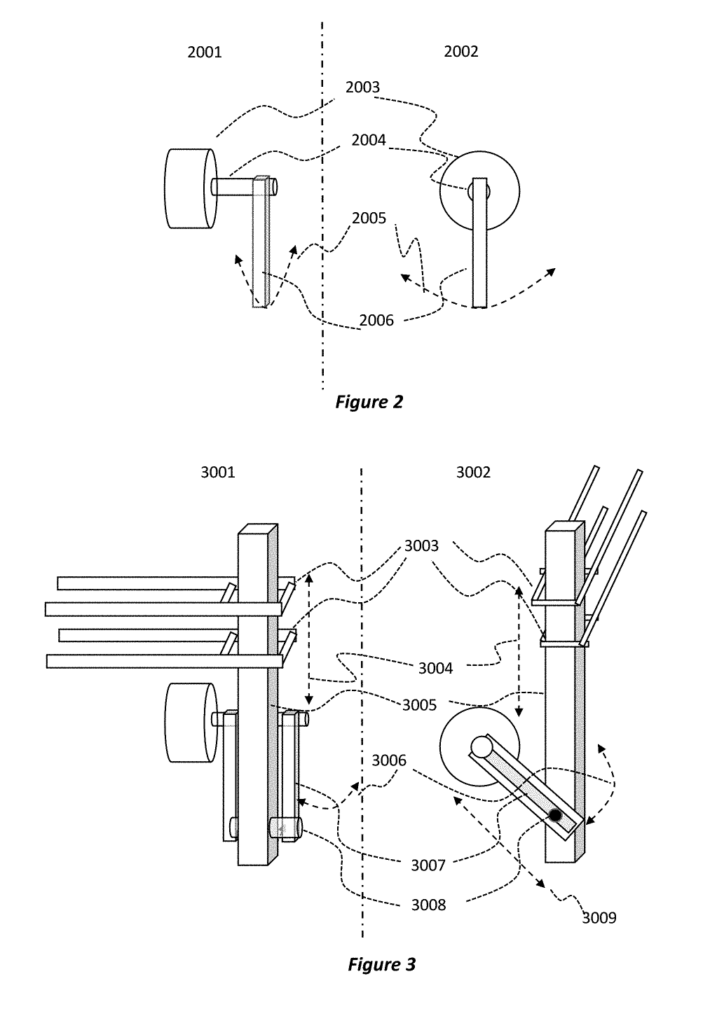

Positional variance can be provided by the motor by either angular change corresponding to the sensed distance FIG. 2, or linear change corresponding to the sensed distance FIG. 3.

FIG. 2 depicts two views of the same attachment. View 2001 shows the side view and view 2002 shows the front view. In this configuration distance feedback is provided as an angular change of the angular variance attachment 2006. This is attached to the motor shaft 2004 of the motor 2003. When the motor rotates the shaft the attachment 2006 rotates and provides angular feedback 2005 for the sensed distance.

FIG. 3 depicts two views of the same attachment. View 3001 shows the side view and view 3002 shows the front view. In this configuration distance feedback is provided as a linear movement 3004 by the linear variance shaft attachment 3005. When the motor rotates 3006, the shaft attachment slides 3009 the bolt attachment 3008 attached to the linear variance shaft 3005 by sliding in the groove 3007. This makes the linear variance shaft 3005 to move up or down based on the rotational angle. Shaft holders 3003 hold the linear variance shaft 3005 to confirm to linear motion.

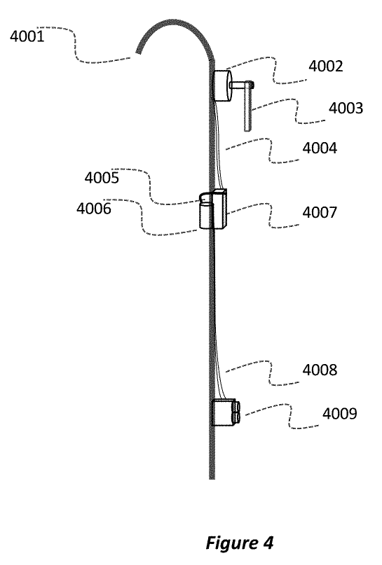

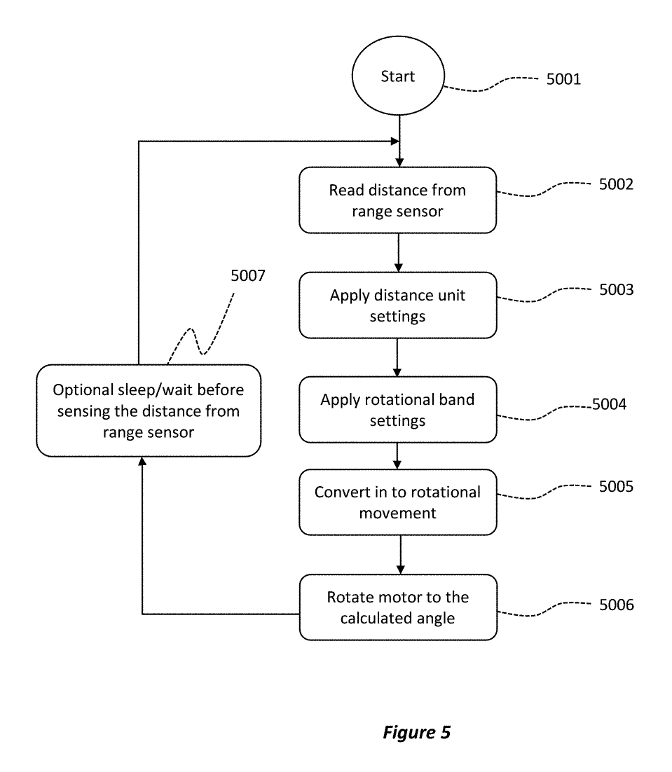

FIG. 4 shows the positional variance distance sensing apparatus being used with a walking stick 4001 to provide distance information sensed by the range sensor 4009 via angular variance attachment 4003. Microcontroller 4007 receives power 4005 from a battery power source 4006. Microcontroller is also connected 4008 to the range sensor for sensing the distance and connected 4004 to the motor 4002 to provide angular variance for the distance sensed. As shown in its current configuration, range sensor and motor are physically connected by wires 4004, 4008, but in cases where range sensor and motor has their own power supplies and capability to communicate wirelessly via Bluetooth, WiFi or any other means of communication including but not limited to internal network, internet, private network, virtual private network, cloud etc., the apparatus works in the same way. In such cases, microprocessor, range sensor and motor can be physically located in different places but perform together as a unit.

1. A positional variance based distance sensing apparatus providing distance feedback using positional difference comprising of:

2. One or more range/distance sensors providing the distance information to the microcontroller.

3. A motor like stepper motor where the angle of rotation can be controlled by the microcontroller.

4. A microcontroller that can receive data from range sensor to do the computation required and turn the motor accordingly to relay the distance information as a positional variance.

5. A power source like battery that can provide power required for the micro controller, range sensor(s), motor(s).

6. Angular variance attachment that provides angular variance based on the distance sensed.

7. A linear variance attachment that provides the linear variance based on the distance sensed.

8. A possible configuration of the apparatus with separate range sensor(s) and motor(s) with individual power supplies and ability to communicate with the microcontroller in wired or wireless fashion.

9. A provision to fine tune angular rotation based on distance unit settings.

10. A provision to support rotational band settings for more systematic and step wise distance feedback from the motor.
